(19) United States
(12) Patent Application Publication
(10) Pub. No.: US 2017/0118691 A1
(43) Pub. Date: Apr. 27, 2017

(54) VEHICLE AD HOC NETWORK ROUTING METHOD, DEVICE AND SYSTEM BASED ON WIRELESS ACCESS IN VEHICULAR ENVIRONMENTS

(71) Applicant: Leauto Intelligent Technology (BEIJING) Co. Ltd., Beijing (CN)

(72) Inventors: Yu Zou, Beijing (CN); Yong Xu, Beijing (CN); Wenrui Li, Beijing (CN); Kunsheng Chen, Beijing (CN); Wei Lin, Beijing (CN); Dan Li, Beijing (CN); Peng Liu, Beijing (CN)

(21) Appl. No.: 14/981,687

(22) Filed: Dec. 28, 2015

(30) Foreign Application Priority Data
Oct. 22, 2015 (CN) 201510695577.3

(51) Int. Cl. H04W 40/02; H04W 4/02; H04W 4/00

(52) U.S. Cl. CPC H04W 40/02; H04W 4/008; H04W 4/023; H04W 84/18

(57) ABSTRACT

In some embodiments, a vehicle ad hoc network routing method based on WAVE (Wireless Access in Vehicular Environments), includes: generating one or more random ID; packaging an arbitrary random ID among the one or more random ID in a WAVE message; and sending the WAVE message through a DSRC short message, and recording the random ID packaged in the WAVE message in a message forwarding record queue. Embodiments of a vehicle ad hoc network routing device and system based on WAVE are also disclosed. Message routing and forwarding in an Ad hoc network can be achieved.

### CROSS-REFERENCE TO RELATED APPLICATIONS

This application claims the benefit of Chinese Patent Application No. 201510695577.3, filed on Oct. 22, 2015, and which is hereby incorporated by reference in its entirety.

### BACKGROUND

Field of Invention

The present disclosure relates to the field of vehicle networking technology, and specifically relates to a vehicle ad hoc network routing method, device and system based on WAVE (Wireless Access in Vehicular Environments).

Description of Related Art

General mobile communication networks are operated based on preset network infrastructure, for example, 3G/4G cellular mobile communication systems are operated via base stations, such wireless local area networks as Wi-Fi and the like access as wireless access points AP (Access Point) via wireless routers or the like. Considering such reasons as communication time delay, base station cost and the like, this kind of mobile communication networks is not suitable for real-time communication of vehicles which travel at high speeds and change dynamically, and since the vehicles serving as terminal nodes move dynamically at high speeds, the instantaneity requirement on routing information is high. An Ad hoc (point to point) network especially refers to a wireless ad hoc network, which derives from the application in the American military field and has the characteristics of no infrastructure support, temporary establishment, dynamic topological changes, etc. The concept of Ad hoc has been introduced into the field of vehicle environment in the civil domain and is called a vehicle ad hoc network VANET (Vehicle Ad Hoc Network).

In practical application, common mobile communication networks have infrastructure, the wireless routing is relatively fixed, a message forwarding strategy is in the charge of a router, and routing convergence is relatively easy. For the Ad hoc network having no infrastructure, the largest application difficulty in the vehicle environment is message routing and forwarding. Since the terminal node also assumes a routing role, the node position changes relatively dynamically, and no fixed rule can be followed, so that the message routing and forwarding of the Ad hoc network has always been a problem in the industry.

At present, although some research institutes propose some solutions to the routing and forwarding of Ad hoc, the solutions are basically similar to the forwarding of wireless networks having infrastructure and refer to the theory of wired routing, the algorithm is complex, the CPU and internal memory costs are high, the research and implementation costs are high, and the convergence effect is poor. Several existing representative Ad hoc routing and forwarding strategies are listed as follows:

a) destination sequence distance vector routing (DSDV): each mobile node needs to maintain a routing table, the routing table entries include a destination node, a hop count and a sequence number of the destination node, wherein the sequence number of the destination node is allocated by the destination node, is mainly used for judging whether the routing is outdated and can prevent the generation of a routing loop, and the defect lies in that only one route is provided between source and destination nodes and one-way connection is not supported.

b) Cluster head gateway switch routing (CGSR): this is a hierarchical routing protocol, a cluster head controls a node group, such as channel access, routing and bandwidth allocation, and the CGSR uses DSDV as a bottom protocol to periodically exchange group member table information and an LCC cluster plan with neighbor nodes, so as to form a cluster and an election cluster head. The protocol uses a sequence number to obtain a non-loop route, so as to avoid old routing entries, but it is very difficult to maintain the cluster in a mobile environment.

c) Ad Hoc on-demand distance vector routing (AODV): AODV is established on the basis of the DSDV, and the difference with the DSDV lies in that the AODV is a reactive routing protocol. The disadvantages of the AODV are similar to those of the DSDV.

### SUMMARY

One or more embodiments includes a vehicle ad hoc network routing method, device and system based on WAVE.

One or more embodiments includes a vehicle ad hoc network routing method based on WAVE, including: S101, generating one or more random ID; S102, packaging an arbitrary random ID among the one or more random ID in a WAVE message; S103, sending the WAVE message through a DSRC short message, and recording the random ID packaged in the WAVE message in a message forwarding record queue.

According to one or more embodiments, the message forwarding record queue is an annular queue.

One or more embodiments includes a vehicle ad hoc network routing method based on WAVE, including: S201, generating one or more random ID; S202, packaging an arbitrary random ID among the one or more random ID, a time to live TTL and a timestamp Timesamp in a WAVE message; and S203, sending the WAVE message through a DSRC short message, and recording the random ID packaged in the WAVE message in a message forwarding record queue.

One or more embodiments includes a vehicle ad hoc network routing method based on WAVE, including: S301, after receiving a DSRC short message, obtaining an ID in a WAVE message in the DSRC short message; S302, looking up the ID in a message forwarding record queue; S303, judging whether the message forwarding record queue contains the ID, and if the message forwarding record queue contains the ID, executing S304; if the message forwarding record queue does not contain the ID, executing S305; S304, discarding the WAVE message; and S305, receiving and forwarding the WAVE message, and recording the ID in the message forwarding record queue.

According to one or more embodiments, after S305, the method further includes: calculating a distance based on longitude and latitude in the DSRC short message and local longitude and latitude, and discarding the WAVE message if the distance is greater than 2 km.

One or more embodiments includes a vehicle ad hoc network routing method based on WAVE, including: S401, after receiving a DSRC short message, obtaining an ID, a TTL and a Timesamp in a WAVE message in the DSRC short message; S402, looking up the ID in a message forwarding record queue; S403, judging whether the message forwarding record queue contains the ID, and if the message forwarding record queue contains the ID, executing S404; if the message forwarding record queue does not contain the ID, executing S405; 5404, discarding the WAVE message; S405, receiving and forwarding the WAVE message, recording the ID in the message forwarding record queue, and executing S406; and S406, calculating a time difference of the WAVE message and a local message based on the Timesamp, and discarding the WAVE message if the time difference is greater than 1 second.

According to one or more embodiments, if the time difference is smaller than or equal to 1 second, the method further includes: calculating a distance based on longitude and latitude in the DSRC short message and local longitude and latitude, and discarding the WAVE message if the distance is greater than 2 km.

One or more embodiments includes a vehicle wireless communication system based on WAVE, including a first device and a second device, wherein the first device is used for generating one or more random ID, packaging an arbitrary random ID among the one or more random ID in a WAVE message, sending the WAVE message through a DSRC short message, and recording the random ID packaged in the WAVE message in a message forwarding record queue; the second device is used for, after receiving the DSRC short message, obtaining the ID in the WAVE message in the DSRC short message, looking up the ID in the message forwarding record queue, judging whether the message forwarding record queue contains the ID, and if the message forwarding record queue contains the ID, discarding the WAVE message; if the message forwarding record queue does not contain the ID, receiving and forwarding the WAVE message, and recording the ID in the message forwarding record queue.

One or more embodiments includes a vehicle wireless communication system based on WAVE, including a first device and a second device, wherein the first device is used for generating one or more random ID, packaging an arbitrary random ID among the one or more random ID, a time to live TTL and a timestamp Timesamp in a WAVE message, sending the WAVE message through a DSRC short message, and recording the random ID packaged in the WAVE message in a message forwarding record queue; the second device is used for, after receiving the DSRC short message, obtaining the ID, the TTL and the Timesamp in the WAVE message in the DSRC short message, looking up the ID in the message forwarding record queue, judging whether the message forwarding record queue contains the ID, and if the message forwarding record queue contains the ID, discarding the WAVE message; if the message forwarding record queue does not contain the ID, receiving and forwarding the WAVE message, recording the ID in the message forwarding record queue, calculating a time difference of the WAVE message and a local message based on the Timesamp, and discarding the WAVE message if the time difference is greater than 1 second.

According to the embodiments of the present disclosure, the random ID is generated before packaging the message, the random ID is packaged in the WAVE message, and in a subsequent message routing and forwarding process, nodes judge whether continuing to forward the message through the ID carried in the message. The above-mentioned strategy is used for routing and forwarding the message of the Ad hoc network and has the advantages of simple implementation, timely response, difficult message transmission leakage and the like, and no numerous routing detection messages or complex routing table calculation is needed, so that the practical effect is good under a high-speed and dynamic vehicle environment.

### BRIEF DESCRIPTION OF THE DRAWINGS

FIG. 1 is a flowchart of a vehicle ad hoc network routing method based on WAVE in an embodiment of the present disclosure.

FIG. 2 is a flowchart of a vehicle ad hoc network routing method based on WAVE in another embodiment of the present disclosure.

FIG. 3 is a schematic diagram of a message routing and forwarding path in an embodiment of the present disclosure.

FIG. 4 is a schematic diagram of a package structure of a WAVE message in an embodiment of the present disclosure.

FIG. 5 is a structural block diagram of a vehicle ad hoc network routing device in an embodiment of the present disclosure.

FIG. 6 is a structural block diagram of a vehicle ad hoc network routing device in another embodiment of the present disclosure.

FIG. 7 is a sequence diagram of a vehicle wireless communication system based on WAVE in an embodiment of the present disclosure.

### DETAILED DESCRIPTION

The technical solutions of one or more embodiments of the present disclosure will be described below in detail in combination with the accompanying drawings and specific embodiments.

For a vehicle ad hoc network VANET, dedicated short range communications DSRC (dedicated short range communications) technology can be generally used for achieving inter-vehicle communication. Wireless access in vehicular environments WAVE (Wireless Access in Vehicular Environments) technology is a technology which uses a 5.9 GHz wireless communication frequency band under a DSRC standard, an IEEE802.11P protocol group defines a physical layer standard thereof, and an IEEE1609 protocol group defines a data link layer, a transport layer and the above transmission standard thereof. The WAVE standard only aims at point-to-point communication and does not define the data forwarding and routing strategy under a multi-hop condition.

According to the embodiments of the present disclosure, a random ID (Random ID, for example 16-bit character string) is generated before packaging a message, the random ID is packaged in a WAVE message, and in a subsequent message routing and forwarding process, nodes judge whether continuing to forward the message through the ID carried in the message.

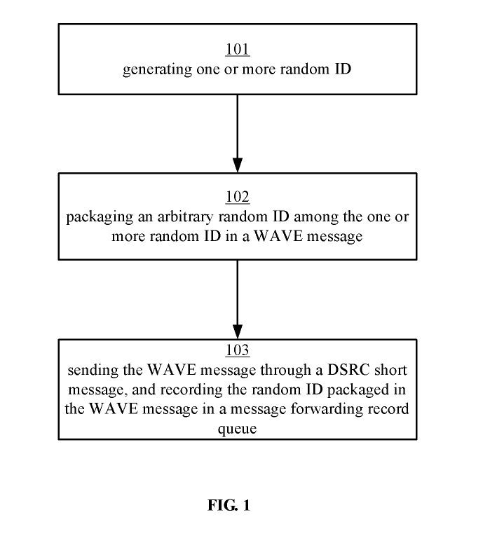

FIG. 1 shows a flowchart of a vehicle ad hoc network routing method based on WAVE in an embodiment of the present disclosure, and the method includes:

a) S101, generating one or more random ID;

b) S102, packaging an arbitrary random ID among the one or more random ID in a WAVE message; and

c) S103, sending the WAVE message through a DSRC short message, and recording the random ID packaged in the WAVE message in a message forwarding record queue.

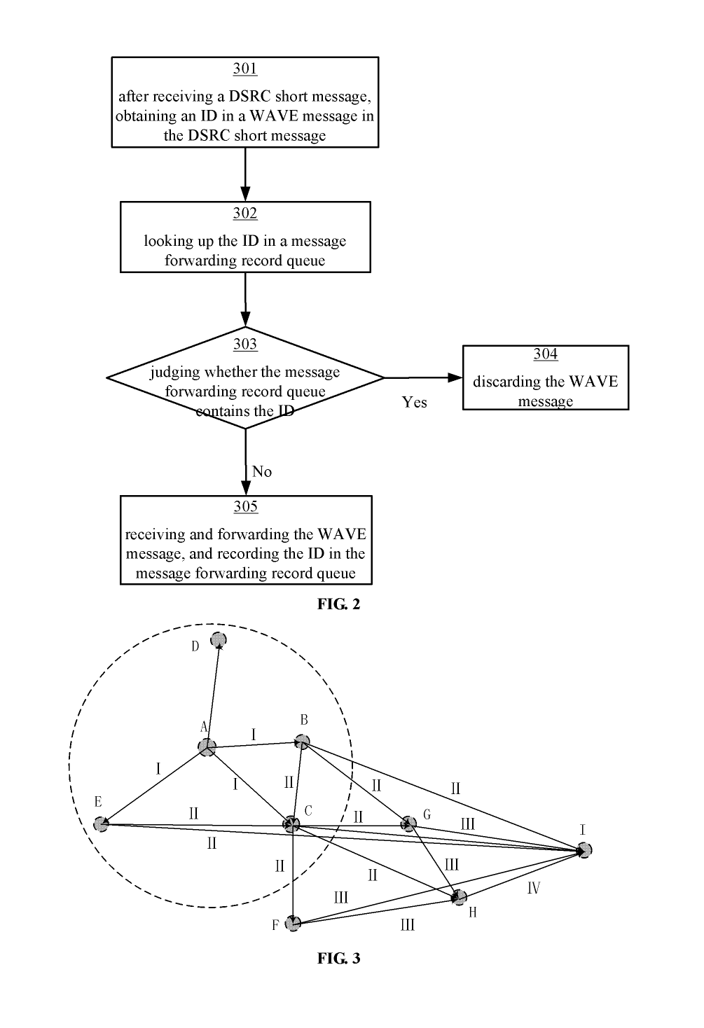

FIG. 2 shows another flowchart of a vehicle ad hoc network routing method based on WAVE in an embodiment of the present disclosure, and the method includes:

a) S301, after receiving a DSRC short message, obtaining an ID in a WAVE message in the DSRC short message;

b) S302, looking up the ID in a message forwarding record queue;

c) S303, judging whether the message forwarding record queue contains the ID, and if the message forwarding record queue contains the ID, executing S304; if the message forwarding record queue does not contain the ID, executing S305;

d) S304, discarding the WAVE message; and

e) S305, receiving and forwarding the WAVE message, and recording the ID in the message forwarding record queue.

The embodiments as shown in FIG. 1 and FIG. 2 respectively describe processing performed by a terminal node serving as a sending terminal and a receiving terminal. In practical application, each terminal node in the Ad Hoc network can both serve as the sending terminal and the receiving terminal.

FIG. 3 exemplarily shows a schematic diagram of a message routing and forwarding path in an embodiment of the present disclosure. An original broadcast message 100 (carrying a random ID) is sent from an A node and arrives at B, C, D, E nodes within a receiving range after I-grade forwarding; after receiving the message 100, the B, C, D, E nodes perform II-grade forwarding on the message, the B, C, D, E nodes also record the ID carried in the message 100, and then the B, C, D, E nodes will not forward the message 100; and so on, after receiving the message 100, F, Q H, I nodes perform III-grade forwarding on the message and record the ID of the message 100. Henceforth, all nodes in FIG. 3 record the ID of the message 100, and then if a certain node receives the message 100 forwarded by arbitrary other nodes, the node will not forward the message. It should be noted that, FIG. 3 is merely a schematic diagram of the routing and forwarding path, and only a part of paths is marked in the figure schematically.

The above-mentioned strategy is used for routing and forwarding the message of the Ad hoc network and has the advantages of simple implementation, timely response, difficult message transmission leakage and the like, and no numerous routing detection messages or complex routing table calculation is needed, so that the practical effect is good under a high-speed and dynamic vehicle environment.

In the embodiment of the present disclosure, the nodes can maintain an annular queue (for example, 1024 items) therein and record the ID of the message in the annular queue. When needing to look up the ID, the nodes look up the ID in the annular queue by adopting a binary search method; when needing to record a new ID, the new ID is inserted in the annular queue according to a size. In the embodiment of the present disclosure, the annular queue is adopted, and the IDs of the messages are ordered according to a sequence from small to large, so that the time of looking up the ID in the nodes can be shortened, and the message forwarding instantaneity is improved.

For the embodiment as shown in FIG. 2, a message forwarding radius constraint can be further set, specifically, after S304, a distance can be calculated based on longitude and latitude in the DSRC short message and local longitude and latitude, this distance is a distance between the position of the sending node of the original message and the position of the current node, and if this distance is greater than 2 km, the current WAVE message is discarded.

The reason why the message forwarding radius constraint is set is illustrated below. According to the routing and forwarding strategy in the embodiment as shown in FIG. 2, for the sending node of the original message, for example, the schematic A node as shown in FIG. 3, it sends the original message to all nodes (B, C, D, E nodes) within the sending range per se, for the B, C, D, E nodes which receive the original message for the first time, the ID of the original message is absolutely an ID that is never seen before, so these nodes will perform II-grade forwarding, and then the nodes may forward the original message or not.

In the above process, with the high speed movement of the nodes in the network, a large amount of redundant messages will be generated. As the effective transmission distance of the WAVE message is designed in such a manner that the WAVE message is stably transmitted within 300 m, considering the movement conditions of actual nodes in one or more embodiments, a message forwarding radius constraint condition is set, namely, when the distance between the current node of the message (for example, the H node, the I node) and the sending node (for example, the A node) of the original message exceeds 2 km, the message is not forwarded anymore.

In the embodiment of the present disclosure, considering the dynamism of the vehicle Ad hoc network, the message over a long period of time is no longer meaningful, therefore the requirement on the message forwarding instantaneity is higher. In view of this, in the embodiment of the present disclosure, besides allocating the random ID to the WAVE message, a TTL (Time To Live, time to live) field can be added in the WAVE message, the message exceeding the TTL value cannot meet the instantaneity requirement anymore, and thus the message should be discarded. To accurately calculate the TTL value of the message, a timestamp Timesamp field also needs to be added and is packaged in the WAVE message together.

For example, assuming that the TTL value is set as 1 s, for the message 100 in the embodiment as shown in FIG. 3, after being sent from the A node and transmitted for 1 s, the message 100 is no longer meaningful, after receiving the message 100, if the H node calculates that the time difference of the message 100 and the local message exceeds 1 s, the H node does not forward or process the message 100 anymore and discards the message 100.

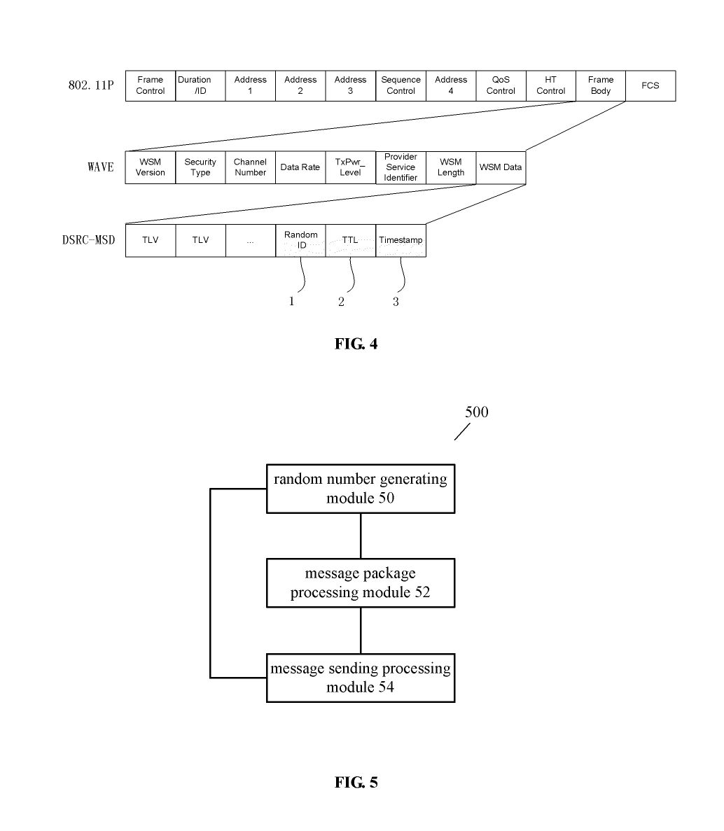

FIG. 4 shows a schematic diagram of a package structure of a WAVE message in an embodiment of the present disclosure, wherein the WAVE message follows an IEEE1609.3 standard regulation, a DSRC short message (Message Set Dictionary) flows an SAE J2735 standard, and the message thereof adopts an ASN.1 variable-length coding format. In a package process, a DSRC basic message set is packaged according to the SAE J2735 standard, including longitude and latitude, heading, a speed, a braking state and the like of the vehicle, and meanwhile, a TTL, a Timestamp and a Random ID generated by a random number generator are packaged.

In the embodiment of the present disclosure, after receiving the WAVE message, the node can further perform address filtering processing on the message. If a source address is an address per se, the node discards the message; if a destination address is a broadcast address or a non-self address, the node receives the message and executes such processing on the message as ID look up, and the like.

In the embodiment of the present disclosure, the vehicle nodes can obtain the longitude and latitude information of the nodes by way of a vehicle global positioning system GPS and can use an on-board diagnostic system OBD (On-Board Diagnostic) to collect vehicle state information, such as a vehicle speed, a braking state or the like, and a 16-bit random ID can be generated by a random number generator.

Corresponding to the process procedures in the embodiment of the present disclosure, the one or more embodiments further provides a vehicle ad hoc network routing device 500 based on WAVE, and as shown in FIG. 5, the vehicle ad hoc network routing device includes:

a) a random number generating module 50, configured to generate one or more random ID;

b) a message package processing module 52, configured to package an arbitrary random ID among the one or more random ID in a WAVE message; and

c) a message sending processing module 54, configured to send the WAVE message through a DSRC short message, and record the random ID packaged in the WAVE message in a message forwarding record queue.

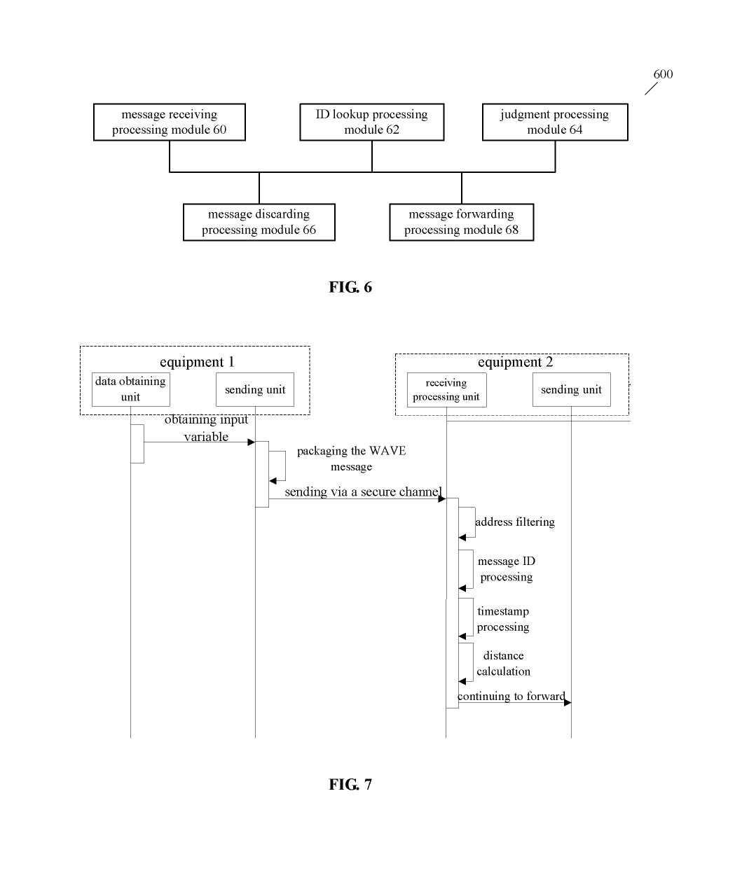

As shown in exemplary FIG. 6, one or more embodiments further provides a vehicle ad hoc network routing device 600 based on WAVE, including:

a) a message receiving processing module 60 configured to, after receiving a DSRC short message, obtain an ID in a WAVE message in the DSRC short message;

b) an ID lookup processing module 62, configured to look up the ID in a message forwarding record queue;

c) a judgment processing module 64, configured to judge whether the message forwarding record queue contains the ID, and if the message forwarding record queue contains the ID, trigger a message discarding processing module 66; if the message forwarding record queue does not contain the ID, trigger a message forwarding processing module 68;

d) the message discarding processing module 66, configured to discard the WAVE message; and

e) the message forwarding processing module 68, configured to receive and forward the WAVE message, and record the ID in the message forwarding record queue.

One or more embodiments further provides a vehicle ad hoc network routing device based on WAVE, comprising: a processor; and a memory for storing instructions executable by the processor; wherein the processor is configured to: generate one or more random ID; package an arbitrary random ID among the one or more random ID in a WAVE message; send the WAVE message through a DSRC short message, and record the random ID packaged in the WAVE message in a message forwarding record queue, wherein the message forwarding record queue is an annular queue.

One or more embodiments further provides a vehicle ad hoc network routing device based on WAVE, comprising: a processor; and a memory for storing instructions executable by the processor; wherein the processor is configured to: generate one or more random ID; package an arbitrary random ID among the one or more random ID, a time to live TTL and a timestamp Timesamp in a WAVE message; send the WAVE message through a DSRC short message, and record the random ID packaged in the WAVE message in a message forwarding record queue, wherein the message forwarding record queue is an annular queue.

One or more embodiments further provides a vehicle ad hoc network routing device based on WAVE, comprising: a processor; and a memory for storing instructions executable by the processor; wherein the processor is configured to: after receiving a DSRC short message, obtain an ID in a WAVE message in the DSRC short message; look up the ID in a message forwarding record queue; judge whether the message forwarding record queue contains the ID, and if the message forwarding record queue contains the ID, trigger a message discarding processing module; if the message forwarding record queue does not contain the ID, trigger a message forwarding processing module; discard the WAVE message; receive and forward the WAVE message, and record the ID in the message forwarding record queue, wherein the processor is further configured to calculate a distance based on longitude and latitude in the DSRC short message and local longitude and latitude, and trigger the message discarding processing module if the distance is greater than 2 km, wherein the message forwarding record queue is an annular queue.

One or more embodiments further provides a vehicle ad hoc network routing device based on WAVE, comprising: a processor; and a memory for storing instructions executable by the processor; wherein the processor is configured to: after receiving a DSRC short message, obtain an ID, a TTL and a Timesamp in a WAVE message in the DSRC short message; look up the ID in a message forwarding record queue; judge whether the message forwarding record queue contains the ID, and if the message forwarding record queue contains the ID, trigger a message discarding processing module; if the message forwarding record queue does not contain the ID, trigger a message forwarding processing module; discard the WAVE message; receive and forward the WAVE message, record the ID in the message forwarding record queue, and trigger a time difference calculation processing module; calculate a time difference of the WAVE message and a local message based on the Timesamp, and trigger the message discarding processing module if the time difference is greater than 1 second, wherein the processor is further configured to calculate a distance based on longitude and latitude in the DSRC short message and local longitude and latitude, and trigger the message discarding processing module if the distance is greater than 2 km, wherein the message forwarding record queue is an annular queue.

One or more embodiments further provides a vehicle wireless communication system based on WAVE, comprising: a first device and a second device, wherein, the first device comprising: a first processor; and a memory for storing instructions executable by the first processor; wherein the first processor is configured to: generate one or more random ID, package an arbitrary random ID among the one or more random ID in a WAVE message, send the WAVE message through a DSRC short message, and record the random ID packaged in the WAVE message in a message forwarding record queue; the second device comprising: a second processor; and a memory for storing instructions executable by the second processor; wherein the second processor is configured to: receive the DSRC short message, obtain the ID in the WAVE message in the DSRC short message, look up the ID in the message forwarding record queue, judge whether the message forwarding record queue contains the ID, and if the message forwarding record queue contains the ID, discard the WAVE message; if the message forwarding record queue does not contain the ID, receive and forward the WAVE message, and record the ID in the message forwarding record queue, wherein the second processor is further configured to calculate a distance based on longitude and latitude in the DSRC short message and local longitude and latitude, and discard the WAVE message if the distance is greater than 2 km.

One or more embodiments further provides a vehicle wireless communication system based on WAVE, comprising a first device and a second device, wherein, the first device comprising: a first processor; and a memory for storing instructions executable by the first processor; wherein the first processor is configured to: package an arbitrary random ID among the one or more random ID, a time to live TTL and a timestamp Timesamp in a WAVE message, send the WAVE message through a DSRC short message, and record the random ID packaged in the WAVE message in a message forwarding record queue; the second device comprising: a second processor; and a memory for storing instructions executable by the second processor; wherein the second processor is configured to: obtain the ID, the TTL and the Timesamp in the WAVE message in the DSRC short message, look up the ID in the message forwarding record queue, judge whether the message forwarding record queue contains the ID, and if the message forwarding record queue contains the ID, discard the WAVE message; and if the message forwarding record queue does not contain the ID, receive and forwarding the WAVE message, record the ID in the message forwarding record queue, calculate a time difference of the WAVE message and a local message based on the Timesamp, and discard the WAVE message if the time difference is greater than 1 second, wherein the second processor is further configured to calculating a distance based on longitude and latitude in the DSRC short message and local longitude and latitude, and discarding the WAVE message if the distance is greater than 2 km.

It can be understood that, the device in the embodiments as shown in FIG. 5 and FIG. 6 should further include a GPS module and a CAN module for collecting vehicle information, and should further include a power module for supplying power to the device system.

In addition, one or more embodiments further provides a vehicle wireless communication platform 700, including at least equipment 1 and equipment 2, wherein the equipment 1 contains the device 500, and the equipment 2 contains the device 600. Referring to FIG. 7, in the embodiment, a data obtaining unit of the equipment 1 obtains the vehicle information from a vehicle OBD, the GPS module and the CAN module and the like and obtains the random ID from the random number generator, a message package processing unit packages the WAVE message based on the obtained data, and a sending unit sends the WAVE message to the equipment 2 via a secure channel. After receiving the message, the equipment 2 performs address filtering at first and performs message ID lookup processing, timestamp processing, distance calculation and other processing after determining that the message is an effective message, and after the series of processing, if the message is still effective, the equipment 2 continues to forward the message.

The technical solutions of the present disclosure have been described above in detail in combination with the specific embodiments, and the described specific embodiments are used for helping to understand the thoughts of the present disclosure. Derivations and deformations made by those skilled in the art based on the specific embodiments of the present disclosure are still encompassed within the protection scope of the present disclosure.

1. A vehicle ad hoc network routing method based on WAVE (Wireless Access in Vehicular Environments), comprising:
generating one or more random IDs;
packaging an arbitrary random ID among the one or more random IDs in a WAVE message;
sending the WAVE message through a DSRC short message; and
recording the random ID packaged in the WAVE message in a message forwarding record queue.

2. The vehicle ad hoc network routing method based on WAVE of claim 1, wherein the message forwarding record queue is an annular queue.

3. A vehicle ad hoc network routing method based on WAVE, comprising:
generating one or more random IDs;
packaging an arbitrary random ID among the one or more random IDs, a time to live TTL and a timestamp in a WAVE message;
sending the WAVE message through a DSRC short message; and
recording the random ID packaged in the WAVE message in a message forwarding record queue.

4. The vehicle ad hoc network routing method based on WAVE of claim 3, wherein the message forwarding record queue is an annular queue.

5. A vehicle ad hoc network routing method based on WAVE, comprising:
after receiving a DSRC short message, obtaining an ID in a WAVE message in the DSRC short message;
looking up the ID in a message forwarding record queue;
judging whether the message forwarding record queue contains the ID;
if the message forwarding record queue contains the ID, discarding the WAVE message; and
if the message forwarding record queue does not contain the ID, receiving and forwarding the WAVE message, and recording the ID in the message forwarding record queue.

6. The vehicle ad hoc network routing method based on WAVE of claim 5, wherein after receiving and forwarding the WAVE message, and recording the ID in the message forwarding record queue, the method further comprises: calculating a distance based on longitude and latitude in the DSRC short message and local longitude and latitude, and discarding the WAVE message if the distance is greater than 2 km.

7. The vehicle ad hoc network routing method based on WAVE of claim 5, wherein the message forwarding record queue is an annular queue.

8. A vehicle ad hoc network routing method based on WAVE, comprising:
after receiving a DSRC short message, obtaining an ID, a TTL and a timesamp in a WAVE message in the DSRC short message;
looking up the ID in a message forwarding record queue;
judging whether the message forwarding record queue contains the ID;
if the message forwarding record queue contains the ID, discarding the WAVE message; and
if the message forwarding record queue does not contain the ID, receiving and forwarding the WAVE message, recording the ID in the message forwarding record queue, and calculating a time difference of the WAVE message and a local message based on the Timesamp, and discarding the WAVE message if the time difference is greater than 1 second.

9. The vehicle ad hoc network routing method based on WAVE of claim 8, wherein if the time difference is smaller than or equal to 1 second, the method further comprises:
calculating a distance based on longitude and latitude in the DSRC short message and local longitude and latitude, and discarding the WAVE message if the distance is greater than 2 km.

10. The vehicle ad hoc network routing method based on WAVE of claim 8, wherein the message forwarding record queue is an annular queue.

11. A vehicle ad hoc network routing device based on WAVE, comprising:
a processor; and
a memory configured to store instructions executable by the processor,
wherein the processor is configured to:
generate one or more random IDs;
package an arbitrary random ID among the one or more random IDs in a WAVE message;
send the WAVE message through a DSRC short message; and
record the random ID packaged in the WAVE message in a message forwarding record queue.

12. The vehicle ad hoc network routing device based on WAVE of claim 11, wherein the message forwarding record queue is an annular queue.

13. A vehicle ad hoc network routing device based on WAVE, comprising:
a processor; and
a memory configured to store instructions executable by the processor, wherein the processor is configured to:
generate one or more random IDs;
package an arbitrary random ID among the one or more random IDs, a time to live TTL and a timestamp in a WAVE message;
send the WAVE message through a DSRC short message; and
record the random ID packaged in the WAVE message in a message forwarding record queue.

14. The vehicle ad hoc network routing device based on WAVE of claim 13, wherein the message forwarding record queue is an annular queue.

15. A vehicle ad hoc network routing device based on WAVE, comprising:
a processor; and
a memory configured to store instructions executable by the processor,
wherein the processor is configured to:
after receiving a DSRC short message, obtain an ID in a WAVE message in the DSRC short message;
look up the ID in a message forwarding record queue;
determine whether the message forwarding record queue contains the ID;
if the message forwarding record queue contains the ID, trigger a message discarding processing module;
if the message forwarding record queue does not contain the ID, trigger a message forwarding processing module;
discard the WAVE message;
receive and forward the WAVE message; and
record the ID in the message forwarding record queue.

16. The vehicle ad hoc network routing device based on WAVE of claim 15, wherein the processor is further configured to calculate a distance based on longitude and latitude in the DSRC short message and local longitude and latitude, and trigger the message discarding processing module if the distance is greater than 2 km.

17. The vehicle ad hoc network routing device based on WAVE of claim 15, wherein the message forwarding record queue is an annular queue.

18. A vehicle ad hoc network routing device based on WAVE, comprising:
a processor; and
a memory configured to store instructions executable by the processor,
wherein the processor is configured to:
after receiving a DSRC short message, obtain an ID, a TTL and a timesamp in a WAVE message in the DSRC short message;
look up the ID in a message forwarding record queue;
determine whether the message forwarding record queue contains the ID;
if the message forwarding record queue contains the ID, trigger a message discarding processing module;
if the message forwarding record queue does not contain the ID, trigger a message forwarding processing module;
discard the WAVE message;
receive and forward the WAVE message, record the ID in the message forwarding record queue, and trigger a time difference calculation processing module;
calculate a time difference of the WAVE message and a local message based on the timesamp; and
trigger the message discarding processing module if the time difference is greater than 1 second.

19. The vehicle ad hoc network routing device based on WAVE of claim 18, wherein the processor is further configured to calculate a distance based on longitude and latitude in the DSRC short message and local longitude and latitude, and trigger the message discarding processing module if the distance is greater than 2 km.

20. The vehicle ad hoc network routing device based on WAVE of claim 18, wherein the message forwarding record queue is an annular queue.

21. A vehicle wireless communication system based on WAVE, comprising: a first device and a second device,
the first device comprising:
a first processor; and
a memory configured to store instructions executable by the first processor,
wherein the first processor is configured to:
generate one or more random IDs, package an arbitrary random ID among the one or more random IDs in a WAVE message, send the WAVE message through a DSRC short message, and record the random ID packaged in the WAVE message in a message forwarding record queue;
the second device comprising:
a second processor; and
a memory configured to store instructions executable by the second processor,
wherein the second processor is configured to:
receive the DSRC short message, obtain the ID in the WAVE message in the DSRC short message, look up the ID in the message forwarding record queue, determine whether the message forwarding record queue contains the ID, and if the message forwarding record queue contains the ID, discard the WAVE message; if the message forwarding record queue does not contain the ID, receive and forward the WAVE message, and record the ID in the message forwarding record queue.

22. The vehicle wireless communication system based on WAVE of claim 21, wherein the second processor is further configured to calculate a distance based on longitude and latitude in the DSRC short message and local longitude and latitude, and discard the WAVE message if the distance is greater than 2 km.

23. A vehicle wireless communication system based on WAVE, comprising a first device and a second device,
the first device comprising:
a first processor; and
a memory configured to store instructions executable by the first processor, wherein the first processor is configured to:
package an arbitrary random ID among the one or more random IDs, a time to live TTL and a timestamp in a WAVE message, send the WAVE message through a DSRC short message, and record the random ID packaged in the WAVE message in a message forwarding record queue;
the second device comprising:
a second processor; and
a memory configured to store instructions executable by the second processor,
wherein the second processor is configured to:
obtain the ID, the TTL and the Timesamp in the WAVE message in the DSRC short message, look up the ID in the message forwarding record queue, determine whether the message forwarding record queue contains the ID, and if the message forwarding record queue contains the ID, discard the WAVE message; and if the message forwarding record queue does not contain the ID, receive and forwarding the WAVE message, record the ID in the message forwarding record queue, calculate a time difference of the WAVE message and a local message based on the Timesamp, and discard the WAVE message if the time difference is greater than 1 second.

24. The vehicle wireless communication system based on WAVE of claim 23, wherein the second processor is further configured to calculating a distance based on longitude and latitude in the DSRC short message and local longitude and latitude, and discarding the WAVE message if the distance is greater than 2 km.
